(19) United States
(12) Patent Application Publication
(10) Pub. No.: US 2009/0123695 A1
(43) Pub. Date: May 14, 2009

(54) Cover tape and electronic component packaging system using the cover tape

(75) Inventor: Moon-Soo Han, Cheonan-si (KR)

Correspondence Address: HARNESS, DICKEY & PIERCE, P.L.C., P.O. BOX 8910, RESTON, VA, 20195, US

(73) Assignee: Samsung Electronics Co., Ltd.

(21) Appl. No.: 12/289,753

(22) Filed: Nov. 3, 2008

(30) Foreign Application Priority Data
Nov. 14, 2007 (KR) 10-2007-0115812

(51) Int. Cl. B32B 3/10

(52) U.S. Cl. 428/134; 428/138

(57) ABSTRACT

Provided are a cover tape and an electronic component packaging system using the cover tape. According to example embodiments, a cover tape may include a core cover part configured to cover a core upper part of a structure with a serial insertion of a plurality of parts, a periphery junction part on both sides of the core cover part configured to adhere to an upper periphery of the structure, and a cut part between the core cover part and the periphery junction part configured to lie over the upper periphery of the structure.

### PRIORITY STATEMENT

This application claims priority under 35 U.S.C. §119 to Korean Patent Application 10-2007-0115812, filed on Nov. 14, 2007, in the Korean Intellectual Property Office (KIPO), the entire contents of which are herein incorporated by reference.

### BACKGROUND

1. Field

Example embodiments relate to a cover tape and an electronic component packaging system having the same, and more particularly, to a cover tape capable of being separated from a carrier tape and an electronic component packaging system having the same.

2. Description of the Related Art

Prior to distribution, semiconductor chip packages are often mounted in a packaging system to protect them from electrical and/or mechanical shock. Various kinds of packaging systems are available to distributors of semiconductor chips, e.g., tray packaging systems, tube packaging systems, and/or packaging systems using carrier tape formed of plastic material.

Adhesive type carrier tapes and embossed type carrier tapes are commonly used in packaging systems. The adhesive type carrier tape uses a structure wherein a semiconductor chip protective tape adheres to a surface-processed paper. The embossed type carrier tape uses an embossed carrier type of plastic material wherein a cover tape may be heat sealed at the periphery of a pocket to store a semiconductor chip. The packaging system employing the adhesive type carrier tape is not proper for commercial use because it causes a secondary pollution through the adhesive material for attaching/detaching the protective tape. Accordingly, the embossed carrier type carrier tape is in commercial use.

A conventional electronic component packaging system, employing an embossed carrier type carrier tape, may include a carrier tape with a plurality of pockets for storing a plurality of semiconductor chips and a pocket guide. A cover tape for covering the upper part of the plurality of pockets may be heat sealed to the pocket guide. Heat sealing may occur at a given or predetermined uniform pressure, along the pocket guide on both sides the plurality of pockets.

Electronic components may be exposed by peeling off the cover tape from the carrier tape. The cover tape may have a peel-off strength of a given or predetermined range from the carrier tape. If the peel-off strength is too low, the cover tape may prematurely separate. If the peel-off strength is too high, the carrier tape may vibrate when the cover tape is peeled away causing electronic components to jump out.

Education Industries Association has selected an international protocol for peel-off strength. For example, a peel-off strength of 0.1N˜1.0N(10 g˜100 g) is applied to carrier tapes of 8 mm width, 0.1N˜1.3N(10 g˜130 g) to carrier tapes of 12 mm to 56 mm width, and 0.1N˜1.5N(10 g˜150 g) to carrier tapes of 72 mm.

However, because continuously maintaining and managing conditions to match to a peel-off strength proper to corresponding kinds of carrier tape and cover tape may be difficult, productivity may be decreased.

Further, when materials of the carrier tape and cover tape are partially changed, or a peripheral environment for heat adhesion of carrier tape and cover tape is changed, a defect rate of peel-off strength may increase, thus, a production yield may decrease.

Furthermore, as users require a diverseness of peel-off strength or a restricted peel-off strength, the heat adhesion condition of carrier tape and cover tape needs to be precisely controlled and, thus, productivity may decrease.

### SUMMARY

Example embodiments provide a cover tape and an electronic component packaging system having the same.

According to example embodiments, a cover tape may include a core cover part configured to cover a core upper part of a structure with a serial insertion of a plurality of parts, a periphery junction part on both sides of the core cover part configured to adhere to an upper periphery of the structure, and a cut part between the core cover part and the periphery junction part configured to lie over the upper periphery of the structure.

According to example embodiments, an electronic component packaging system may include a carrier tape including a plurality of pockets into which a plurality of semiconductor chips may be inserted and a pocket guide for arraying the plurality of pockets in line, a cover tape including a core cover part configured to cover an upper part of the plurality of pockets, a periphery junction part configured to adhere the cover tape to the pocket guide on both sides of the core cover part, and a cut part over the pocket guide and configured to open the plurality of pockets when the core cover part is separated from the periphery junction part.

According to example embodiments, an electronic component packaging system may include a carrier tape with a plurality of pockets into which a plurality of semiconductor chips may be inserted, the plurality of pockets are arrayed in line and include pocket guides adapted with a given or predetermined interval, and a cover tape including a core cover part covering the plurality of pockets into which the plurality of semiconductor chips are inserted and a periphery junction part adhering to the pocket guides, and a cut part overlying the pocket guides and configured to separate the core cover part from the carrier tape.

### BRIEF DESCRIPTION OF THE DRAWINGS

Example embodiments will be more clearly understood from the following detailed description taken in conjunction with the accompanying drawings. FIGS. 1-5 represent non-limiting, example embodiments as described herein.

FIG. 1 is a perspective view of electronic component packaging system according to example embodiments;

FIG. 2 is a sectional view of FIG. 1;

FIG. 3 is a plan view illustrating a cover tape according to example embodiments;

FIG. 4 is a plan view illustrating a cover tape according to example embodiments; and

FIG. 5 is a plan view illustrating a cover tape according example embodiments.

### DETAILED DESCRIPTION OF EXAMPLE EMBODIMENTS

Example embodiments will now be described more fully with reference to the accompanying drawings, in which example embodiments are shown. Example embodiments may, however, be embodied in different forms and should not be construed as limited to the embodiments set forth herein. Rather, these embodiments are provided so that this disclosure will be thorough and complete, and will fully convey the scope of example embodiments to those skilled in the art. In the drawings, the sizes of components may be exaggerated for clarity.

It will be understood that when an element or layer is referred to as being “on”, “connected to”, or “coupled to” another element or layer, it can be directly on, connected to, or coupled to the other element or layer or intervening elements or layers that may be present. In contrast, when an element is referred to as being “directly on”, “directly connected to”, or “directly coupled to” another element or layer, there are no intervening elements or layers present. As used herein, the term “and/or” includes any an all combinations of one or more of the associated listed items.

It will be understood that, although the terms first, second, etc. may be used herein to describe various elements, components, regions, layers, and/or sections, these elements, components, regions, layers, and/or sections should not be limited by these terms. These terms are only used to distinguish one element, component, region, layer, and/or section from another element, component, region, layer, and/or section. Thus, a first element, component, region, layer, or section discussed below could be termed a second element, component, region, layer, or section without departing from the teachings of example embodiments.

Spatially relative terms, such as “beneath”, “below”, “lower”, “above”, “upper”, and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

Embodiments described herein will refer to plan views and/or cross-sectional views by way of ideal schematic views. Accordingly, the views may be modified depending on manufacturing technologies and/or tolerances. Therefore, example embodiments are not limited to those shown in the views, but include modifications in configuration formed on the basis of manufacturing processes. Therefore, regions exemplified in figures have schematic properties and shapes of regions shown in figures exemplify specific shapes or regions of elements, and do not limit example embodiments.

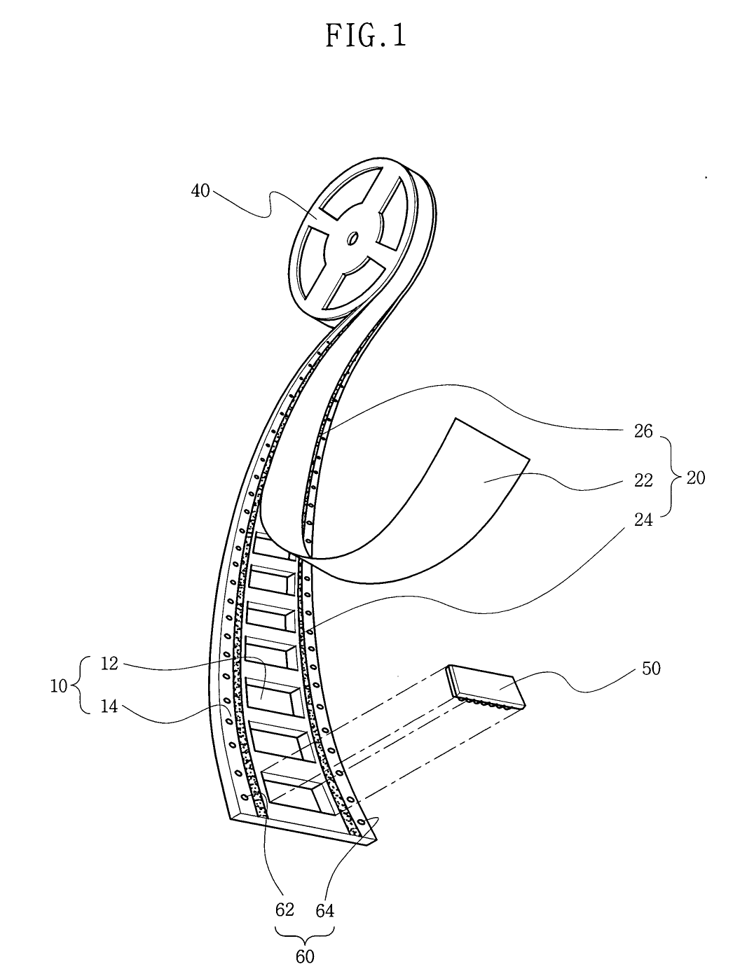

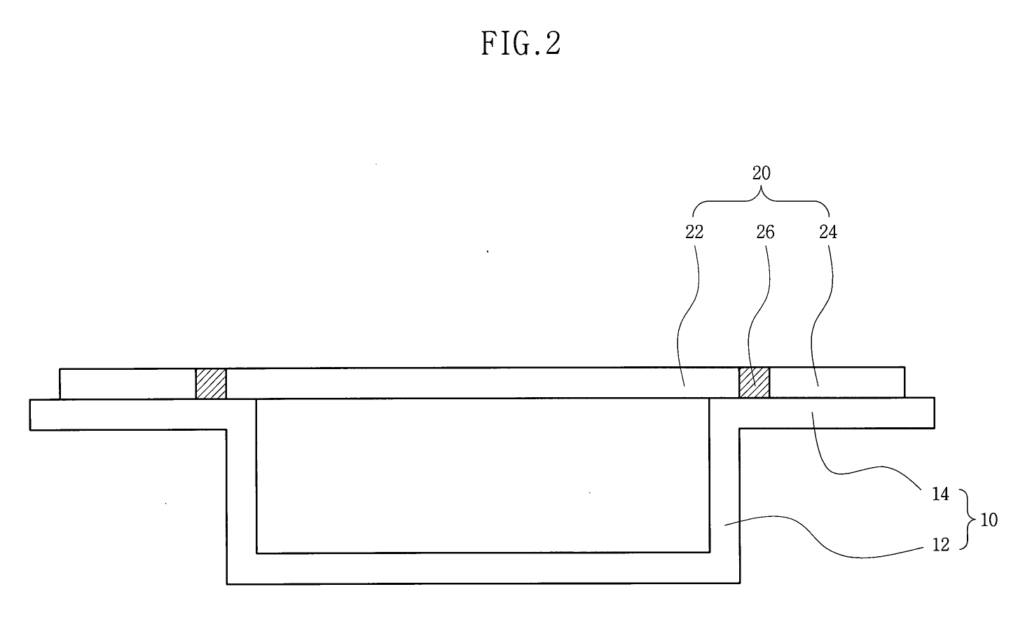

FIG. 1 is a perspective view of electronic component packaging system according to example embodiments, and FIG. 2 is a sectional view of FIG. 1. As shown in FIG. 1, an electronic component packaging system according to example embodiments may include a carrier tape 10 and cover tape 20 to cover a pocket 12 provided within a carrier tape 10. The carrier tape 10 may be wound round on a circular reel 40 having a given radius in a clockwise or counterclockwise direction. For example, the carrier tape 10 may include a plurality of pockets 12 storing a plurality of electronic components 50, e.g., semiconductor chips, and a pocket guide 14 as a supporter for moving, in line, the plurality of pockets 12. The plurality of pockets 12 may have a cavity in an embossed shape to store the electronic components 50 of a given size in a center part of the pocket guide 14. The plurality of pockets 12 may be formed to have a three-dimensional shape corresponding to a rectangular shape when the semiconductor chips are stored therein.

The pocket guide 14 may be adapted to regularly array a plurality of pockets 12. The edge part of the pocket guide 14 may include sprocket holes 60 formed with a uniform interval. A sprocket of a packaging device (not shown) may be inserted into the sprocket holes 60 to move the plurality of pockets 12 a given or predetermined interval. The sprocket holes 60 may be round sprocket holes 62 or elongated sprocket holes 64. For example, in a pocket guide 14 having a width of about 24 mm or below, round sprocket holes 62 may be formed along one side edge thereof. In a pocket guide 14 having a width of about 32 mm or more, round sprocket holes 62 may be formed on one side edge part, and elongated sprocket holes 64 may be formed on the other edge.

The cover tape 20 may be adapted to cover an upper part of the pocket 12 in the packaging of the carrier tape 10 so as not to externally expose electronic parts 50 stored inside the pocket 12. The cover tape 20 may be heat sealed with the pocket guide 14 of both edges of the carrier tape 10. The cover tape 20 may seal the pocket 12 so that the electronic parts 50 may not escape from the pocket 12 of the carrier tape 10.

The cover tape 20 may be separated from the carrier tape 10 to remove or place electronic components 50 in the pocket 12. The cover tape 20 may include a core cover part 22 to cover an upper part of a plurality of pockets 12 formed along a center of the carrier tape 10. The cover tape 20 may also include a periphery junction part 24 for adhering the cover tape to a pocket guide 14 that may be located at the periphery of the pocket 12. The cover tape may also include a cut part 26 so that the core cover part 22 may be separated from the periphery junction part 24 to open the inside of the plurality of pockets 12 regardless of a junction of the periphery junction part 24.

The core cover part 22 may be formed of transparent material so that electronic components 50 stored within the pocket 12 may be visually inspected. Further, letters may be indexed in the core cover part 22 by using a difference of light and shade ratio.

The periphery junction part 24 may be adhered to the pocket guide 14 with a given or predetermined level of adhesion strength. The periphery junction part 24 may adhere onto the pocket guide 14, and thus, the cover tape 20 may produce one flat face. The periphery junction part 24 and the pocket guide 14 may melt and adhere to each other by heat from a relatively high temperature for a given or predetermined time, and the adhesion may be fixed when returning to a normal temperature. In the periphery junction part 24, a given or predetermined peel-off strength may be required in the conventional art, but in example embodiments, a specific peel-off strength is not required. Therefore, a heat seal condition of the periphery junction part 24 may not be complicated and the periphery junction part 24 may be fixed to the carrier tape 10 by a given or predetermined level or more of adhesion.

The cut part 26 may be adapted to separate the core cover part 22 from the periphery junction part 24 in the open case of the cover tape 20. The cut part 26 may be formed of relatively weak material or structure as compared with the core cover part 22 and the periphery junction part 24. Further, the cut part 26 may be adapted so that the pocket 12 may be more easily exposed by removing the core cover part 22 covering an upper part of the pocket 12 when the periphery junction part 24 adheres onto the pocket guide 14 of both edges of the pocket 12.

Accordingly, an electronic component packaging system according to example embodiments may be provided so that a continuous maintenance of conditions to match the peel-off strength may not be required by using the cover tape 20 provided with the cut part 26 for selectively opening the upper part of the pocket 12 in a state of being adhered to the carrier tape 10, thereby increasing productivity. Non-limiting examples of a cut part 26 adapted in the cover tape 20 of the electronic component packaging system with the configuration described above are described in detail as follows, with example embodiments.

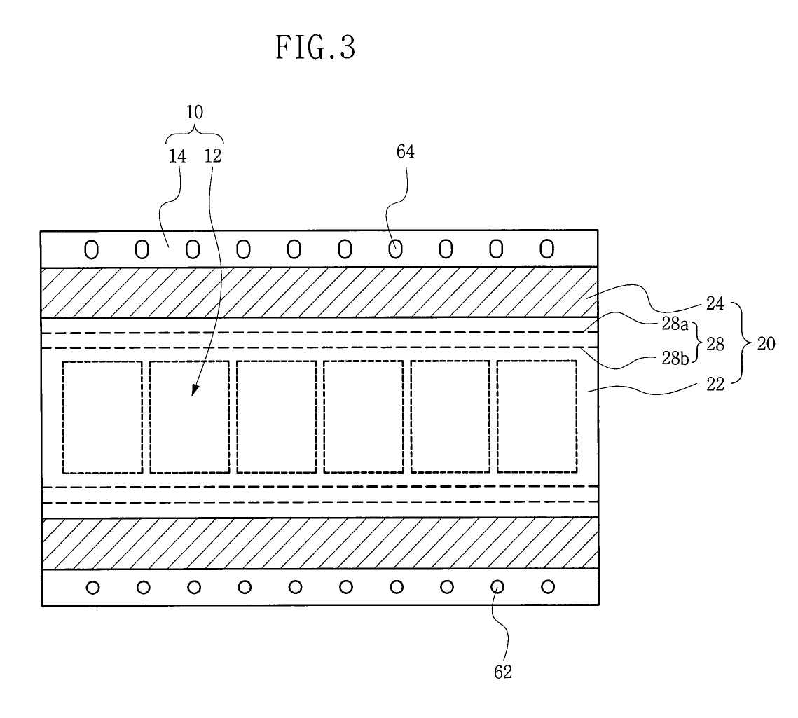

FIG. 3 is a plan view illustrating cover tape 20 according to example embodiments. As shown in FIG. 3, the cover tape 20 according to example embodiments may include a plurality of unsealed lines 28 formed between the core cover part 22 and the periphery junction part 24. The plurality of unsealed lines 28 may include a plurality of needle holes or scratches formed with a given or predetermined interval.

For example, the plurality of unsealed lines 28 may include a plurality of needle holes having an interval of about 0.5 mm to 3 mm and a diameter of about 1 mm to 5 mm. Further, the plurality of unsealed lines 28 may include a plurality of scratches having an interval of about 1 mm to 5 mm and the size of about 1 mm to 7 mm. The plurality of unsealed lines 28 may be different from the size and interval of the plurality of needle holes or scratches depending upon the material of the cover tape 20.

The plurality of unsealed lines 28 may be formed near the periphery junction part 24 of the cover tape 20 in a position corresponding to an upper part of a pocket guide 14 on the periphery of a pocket 12. The portion of the cover tape 20 in contact with the pocket guide 14 may not interfere in handling the electronic components 50 stored inside the pocket 12. Therefore, the plurality of unsealed lines 28 may be adapted in the cover tape 20 in a position corresponding to an upper part of the pocket guide 14 on the periphery of the pocket 12.

The plurality of unsealed lines 28 may be a boundary line separating the core cover part 22 from the periphery junction part 24 and may be recognizable. For example, the plurality of unsealed lines 28 may include a main unsealed line 28a formed adjacent to the periphery junction part 24 of both edges of the cover tape 20, and a reserve unsealed line 28b formed in a parallel direction with the main unsealed line 28a in an inner side of the main unsealed line 28a.

The main unsealed line 28a is usable when cutting along the main unsealed line 28a fails. The reserve unsealed line 28b may be a safe line to prevent or reduce the core cover part 22 from escaping from the main unsealed line 28a. Thus, the reserve unsealed line 28b may be formed between the periphery junction part 24 and the core cover part 22. In the reserve unsealed line 28b, pluralities of needle holes or scratches may be formed in parallel with the main unsealed line 28a. The main unsealed line 28a may be formed of needle holes or scratches having the same or similar interval to the reserve unsealed line 28b, or needle holes or scratches having an interval finer than that of the reserve unsealed line 28b.

For example, the main unsealed line 28a and reserve unsealed line 28b may be formed of needle holes or scratches having the same or similar interval. The needle holes or scratches of the main unsealed line 28a and the reserve unsealed line 28b may be formed deviated from one another. For example, the core cover part 22 may be separated from the periphery junction part 24 and the main unsealed line 28a and the reserve unsealed line 28b may be opened in a zigzag shape.

Accordingly, in the cover tape 20 according to example embodiments, an unsealed line 28 formed of a plurality of needle holes or scratches may be formed as the cut part 26 separating the core cover part 22 from the periphery junction part 24, thereby reducing a defect rate of peel-off strength regardless of a material change of cover tape 20 and a change of peripheral environment, thus increasing a production yield.

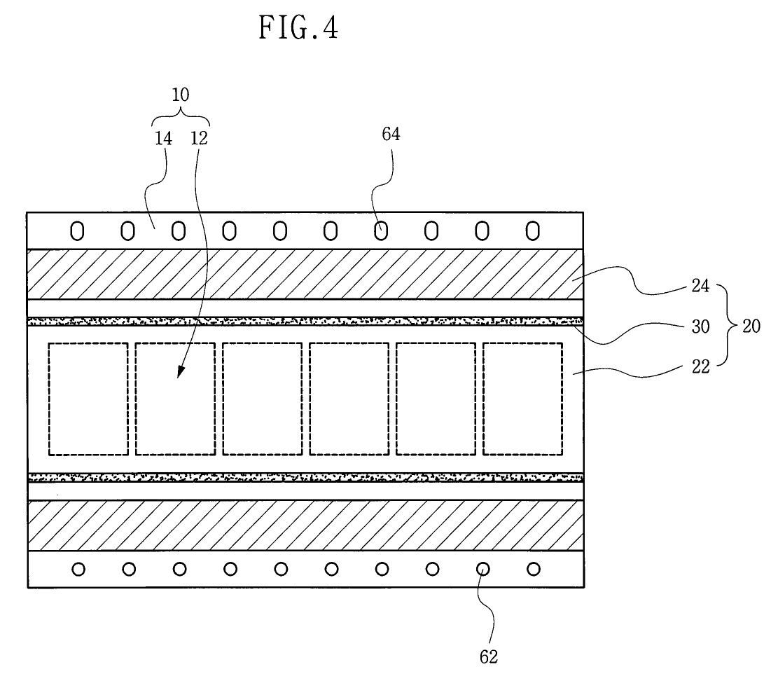

FIG. 4 is a plan view illustrating cover tape 20 according to example embodiments. As shown in FIG. 4, the cover tape 20 according to example embodiments may include a plurality of unsealed bands 30 formed between the core cover part 22 and the periphery junction part 24. The plurality of unsealed bands 30 may be formed with a given width in the boundary between the core cover part 22 and the periphery junction part 24. For example, the plurality of unsealed bands 30 may be formed with a given width of about 1 mm to 5 mm in one direction in an upper part of the pocket guide 14.

The periphery junction part 24 and the core cover part 22 may be separated from one another but may be held together by a plurality of unsealed bands 30 which may be formed to overlap with the upper part of the periphery junction part 24 and the core cover part 22. The plurality of unsealed bands 30 adhering to the periphery junction part 24 and the core cover part 22 may keep the periphery junction part 24 and the core cover part 22 from separating even when subjected to horizontal tension loads. The periphery junction part 24 and the core cover part may be separated when the plurality of unsealed bands 30 are eliminated.

The plurality of unsealed bands 30 may be formed of a material having a prominent tension strength in the boundary between the core cover part 22 and the periphery junction part 24 of the cover tape 20 that may be formed with a vertical stack of a plurality of films. For example, the cover tape 20 may be largely formed of an outer layer, middle layer and inner layer. The outer layer may include an electric-charge-prevention layer coated with ammonium tetrachloride. The middle layer may include at least one of polyester film, polypropylene film, nylon film, polyurethane film, acrylic film, polyvinylchloride film and ethylene-vinyl acetate copolymer film. The inner layer may be a conductive sealant layer, containing conductive oxidation metal or conductive polymer. The plurality of unsealed bands 30 may be adapted along the boundary between the core cover part 22 and the periphery junction part 24 so that a middle layer of the cover tape 20 may be separated selectively. The plurality of unsealed bands 30 may require removal prior to the separation between the core cover part 22 and the periphery junction part 24.

The cover tape 20 according to example embodiments may be adapted to simply separate the core cover part from the periphery junction part 24 regardless of a heat seal condition of the carrier tape 10 and the cover tape 20, by using the unsealed band 30 formed along the boundary between the core cover part and the periphery junction part 24, thereby increasing productivity.

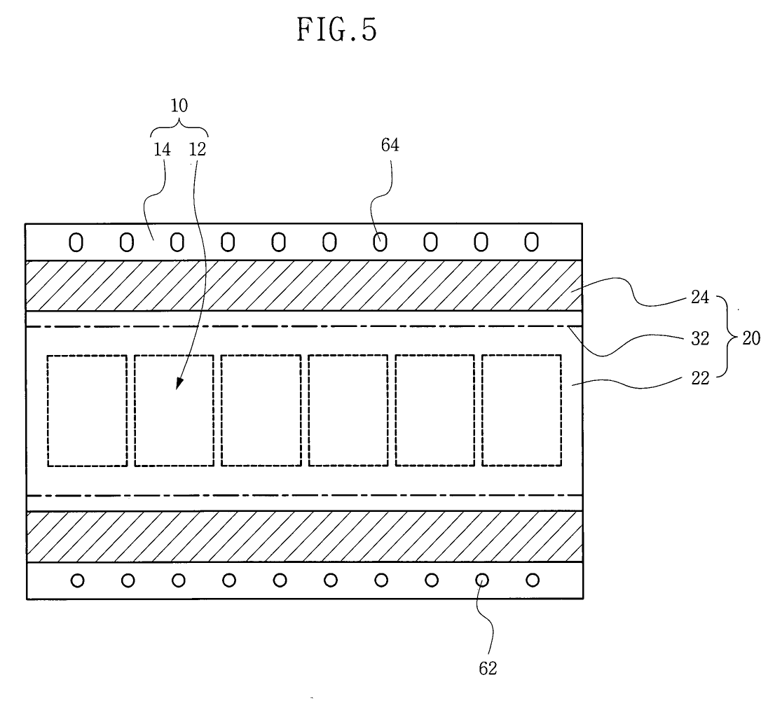

FIG. 5 is a plan view illustrating cover tape 20 according to example embodiments. As shown in FIG. 5, the cover tape 20 according to example embodiments may include a cut part 26 constructed of a plurality of cut lines 32 between the core cover part 22 and the periphery junction part 24.

The plurality of cut lines 32 may include a straight line, dotted line, one-dotted chain line or two-dotted chain line on the boundary between the core cover part 22 and the periphery junction part 24. The plurality of cut lines 32 may be formed so that the cover tape 20 may be cut by using a cutting instrument, e.g., a blade or scissors, between the core cover part 22 and the periphery junction part 24. Further, the plurality of cut lines 32 may be formed to have a relatively weak structure as compared with the core cover part 22 and the periphery junction part 24. For example, the plurality of cut lines 32 may be formed in a relievo or intaglio of about 1 mm from the surface of the cover tape 20. The plurality of cut lines 32 formed in the relievo on the cover tape 20 may be cut by the cutting instrument.

On the other hand, the plurality of cut lines 32 formed in the intaglio may be formed as being recessed on the surface of the cover tape 20. The plurality of cut lines 32 formed in the intaglio may be formed relatively weak as compared with the entire cover tape 20. Thus, the plurality of cut lines 32 formed in the intaglio may be formed to separate the core cover part from the periphery junction part 24 without using a cutting instrument.

The plurality of cut lines 32 may be formed to have a cavity structure or porous structure by removing an internal middle layer of the cover tape 20. In the cover tape 20 constructed of an outer layer, middle layer and inner layer, the middle layer may determine a tension strength. The middle layer may be formed of any combination of a polyester film, a polypropylene film, a nylon film, a polyurethane film, an acrylic film, a polyvinylchloride film, and an ethylene-vinyl acetate copolymer film. In the plurality of cut lines 32, at least one of a plurality of films formed as the middle layer in the boundary between the core cover part 22 and the periphery junction part 24 may be removed, or porosity may be formed in the film. The plurality of cut lines 32 may be printed in ink so as to be recognized by users.

Though not shown in the drawings, a plurality of cut lines 32 may include a plurality of main cut lines adjacent to the periphery junction part 24 of both edges of the cover tape 20, and a plurality of reserve cut lines formed in a parallel direction with the main cut line in an inner side of the main cut line. The main cut line may be formed relatively close to the periphery junction part 24, as a relatively weakest portion in the boundary between the core cover part 22 and the periphery junction part 24. The reserve line may be formed in an inner side of the main cut line as a line usable when cutting along the main cut line fails.

Accordingly, in the cover tape 20 according to example embodiments, a core cover part and the periphery junction part 24 may be easily separated regardless of a heat seal condition of the carrier tape 10 and the cover tape 20, by using the cut line 32 formed in a relievo or intaglio on the surface of cover tape 20 formed along the boundary between the core cover part and the periphery junction part 24, thereby satisfying a requirement of users and increasing productivity.

While example embodiments have been particularly shown and described with reference to example embodiments thereof, it will be understood by those of ordinary skill in the art that various changes in form and details may be made therein without departing from the spirit and scope of the following claims.

What is claimed is:

1. A cover tape comprising:
a core cover part configured to cover a core upper part of a structure with a serial insertion of a plurality of parts;
a periphery junction part on both sides of the core cover part configured to adhere to an upper periphery of the structure; and
a cut part between the core cover part and the periphery junction part configured to lie over the upper periphery of the structure.

2. The cover tape of claim 1, wherein the cut part comprises at least one unsealed line, wherein the at least one unsealed line is a plurality of needle holes or a plurality of scratches at a given interval.

3. The cover tape of claim 2, wherein the plurality of needle holes have an interval of about 0.5 mm to about 3 mm and a diameter of about 1 mm to about 5 mm, and the plurality of scratches have an interval of about 1 mm to about 5 mm and the size of about 1 mm to about 7 mm.

4. The cover tape of claim 2, wherein the at least one unsealed line is a plurality of unsealed lines and the plurality of unsealed lines includes a main unsealed line adjacent to a periphery junction part of both edges of the cover tape, and a reserve unsealed line parallel with the main unsealed line in an inner side of the main unsealed line.

5. The cover tape of claim 4, wherein the main unsealed line and the reserve unsealed line are needle holes or scratches having the same or a similar interval to one another, or needle holes or scratches of the main unsealed line and the reserve unsealed line are deviated from one another.

6. The cover tape of claim 1, wherein the cut part comprises at least one unsealed band between the core cover part and the periphery junction part.

7. The cover tape of claim 6, wherein the at least one unsealed band has a width of about 1 mm to about 5 mm.

8. The cover tape of claim 6, wherein the cover tape includes a plurality of films and the at least one unsealed band is adapted for separation on a middle layer of the plurality of films.

9. The cover tape of claim 1, wherein the cut part comprises a cut line of any one of a straight line, dotted line, one-dot chain line and two-dot chain line between the core cover part and the periphery junction part.

10. The cover tape of claim 9, wherein the cut line is in relievo protruded a given height from a horizontal face of the cover tape or an intaglio depressed a given depth from the horizontal face of the cover tape.

11. The cover tape of claim 10, wherein the cut line in the intaglio has a vacant structure or porous structure in a middle layer formed of the plurality of films of the cover tape.

12. The cover tape of claim 9, wherein the cut line comprises a plurality of main cut lines adjacent to the periphery junction part of both edges of the cover tape, and a plurality of reserve cut lines parallel with the main cut lines in an inner side of the main cut lines.

13. An electronic component packaging system, comprising:
a carrier tape including a plurality of pockets into which a plurality of semiconductor chips are inserted and a pocket guide for arraying the plurality of pockets in line; and
the cover tape of claim 1, wherein the core cover part is configured to cover an upper part of the plurality of pockets, the periphery junction part is configured to adhere the cover tape to the pocket guide on both sides of the core cover part, and the cut part is over the pocket guide and configured to open the plurality of pockets when the core cover part is separated from the periphery junction part.

14. The system of claim 13, wherein the cut part comprises an unsealed line with a plurality of needle holes or a plurality of scratches at a given interval.

15. The system of claim 14, wherein the unsealed line is a plurality of unsealed lines, the plurality of unsealed lines including a main unsealed line adjacent to a periphery junction part of both edges of the cover tape, and a reserve unsealed line parallel with the main unsealed line in an inner side of the main unsealed line.

16. The system of claim 13, wherein the cut part comprises an unsealed band between the core cover part and the periphery junction part.

17. The system of claim 13, wherein the cut part comprises a cut line formed of any one of a straight line, dotted line, one-dot chain line and two-dot chain line between the core cover part and the periphery junction part.

18. An electronic component packaging system comprising:
a carrier tape with a plurality of pockets into which a plurality of semiconductor chips are inserted, the plurality of pockets are arrayed in line and include pocket guides adapted with a given interval; and
the cover tape of claim 1, wherein the core cover part covers the plurality of pockets into which the plurality of semiconductor chips are inserted, the periphery junction part adheres to the pocket guides, and the cut part overlies the pocket guides and is configured to separate the core cover part from the carrier tape.

19. The system of claim 18, wherein the cut part includes an unsealed line of a plurality of needle holes or a plurality of scratches with a given interval.

20. The system of claim 18, wherein the cut part includes a plurality of unsealed lines including a main unsealed line adjacent to a periphery junction part of both edges of the cover tape, and a reserve unsealed line parallel with the main unsealed line in an inner side of the main unsealed line.
